(19) United States
(12) Patent Application Publication
(10) Pub. No.: US 2005/0030190 A1
(43) Pub. Date: Feb. 10, 2005

(54) Personal voice: emergency message, alarm respnder watch

(76) Inventor: Paulette Bernetta Turner, Savanah (GA)

Correspondence Address: Paulette Bernetta Turner, 2115 S. Fernwood Drive, Savannah, GA, 31404, US

(21) Appl. No.: 10/606,377

(22) Filed: Jun. 26, 2003

(51) Int. Cl. G08B 3/00

(52) U.S. Cl. 340/691.1

(57) ABSTRACT

Information is recorded in a digital a tape or tape-less, multiple boxed unit. It will be able to store as many different emergencies, non-emergency messages as possible at one time. It houses a digital processor for retrieving personalized recorded messages from a tape or tape-less device recording and storing digital messages into random access memory. Speaker connected to device to record and playback for transmittal of messages from the first party to the second party. Playback through means of random access memory for storing digitized messages to house a digital generator by receiving and converting personalized-recorded messages into an analog signal and provide said signal to loudspeaker. This invention is portable as well as wall-mountable. It has the awesome ability to assist with more than one emergency at a time, continuously.

### CROSS REFERENCE TO RELATED APPLICATIONS

The present invention generally relates and is similar to a heat censored and or a smoke activated smoke alarm and or emergency devices. It also has similarities to voice answering systems for pre-recorded machines. More particularly to a medical pendant alarm devices with siren warnings and the capabilities to phone for emergency assistance. All the while being portable and able to record vital information.

The present filing was for a Disclosure Document Application of U.S. Pat. No. 528.790 filed on Apr. 4, 2003.

My claim; The PVEMAR, the PVEMAR Watch and the PVEMAR Unit to be:
1. All of the above inventions most importantly can be hand carried, portable and self-contained. It can be worn outside of a person's body as on a chain, rope, string, or anything similar. The digital device being used for recording and retrieving digital personalized recorded messages. Unit is recorded in a digital a tape or tape-less unit or watch.
2. This device can even be inserted in or on wheel chairs, in vehicles, walkers or any other medical assistance devices and or not limited to related objects for inside or outside of the home. All areas of storage is convenient for recording and retrieving of said parties.
3. A medical alarm system for emergency information for recording of a first party message of life saving techniques with a combination of one or more siren or loud tone and personal recorded familiar voice messages for the second party's playback and retrieval.
4. The devices will house a digital sound generator by receiving and converting personalized-recorded messages into an analog signal and provide said signal to loudspeaker.
The devices will house a digital processor for retrieving personalized recorded messages from tape or tape-less device recording and storing digital messages
5. into random access memory to the sound generator.
6. Recorded messages not limited to important, not so important information. Imagine how important this device can be used for the United States Armed Forces? The PVEMAR watch/pendant is far better than any dog tag that the U.S. Armed forces uses. Vital and important information is stored inside to assist wounded, dead or captured soldiers. One would be able to store only what they needed to input for their purpose. Words or codes can be input into the device.
7. These life saving devices relates to a smoke alarm safety device but also familiar to environmental emergency conditions, such as a: smoke, carbon monoxide, fire, etc. The unit is also able to assist in all medical conditions limited and not limited to one or more of man-made, environments, heart conditions, pregnancy, handicaps, nursing homes.
8. Not limited to use by children, adults, animals, pets, patients, elderly, kidnappings, nor people or persons of all kind, all ages, culture or nationality, etc.
9. Not limited to retrieval or translating of messages for or of foreign, different and all languages in need of verbal personalized instructions.
10. Messages of a recorded personalized voice are not recorded on digital tape-less or tapes allowing message to be taped as long as the caller speaks, up to 45 minutes. A PVEMAR Unit can be used for one or more messages.
11. The unit will house a signal to the fire emergency assistance calling circuit through a telephone to a fire department, police station or other emergency personnel, alerting them of the situation.
12. Allowing a recorded personalized voice to be released when triggered by detection of one or more of heat censored, voice commands, smoke detection, panic button release, pushing of on/off buttons, push, remote control, thus allowing a person listening to respond correctly and quickly.
13. The life saving devices such as watches and pendants relates to life threatening and non-life threatening situations.
14. Power failure protection to save messages during an electrical power outage or low battery interruption. Battery powered with rechargeable back-up battery compartments, and electrical powered.
15. The PVEMAR watch can be worn as a pendant, device, necklace, hand carries, bracelet, locket, armlet, wristlet, bangle, ornament, jewelry, brooch, or anything similar. The PVEMAR multiplex system and the PVEMAR unit is compact and ease to carry. It can be placed in a container or unit of plastic, wood, etc., and or natural and not limited to man made materials
16. A person will be able to go anywhere with the PVEMAR, unit responder or multiplex system as it can even be waterproof and worn on boat, beaches, water parks, scuba diving, swimming, pools, etc.
17. Why take a chance on your children, family, elderly love one's, or even friends safety. Why even take a chance on their safety? Most people don't always know what to do in certain emergencies, especially children. What would be the next best thing to assist your love ones? Instructions not limited to fire, tornado, flood, heart attacks, medical conditions will be optional.
18. One touch personal voice messages playback and resets itself to be used time and time again.
19. Digital Device saves messages after listening to them. Can be erased and re-recorded.
20. Flashing message counter with a panic siren button for the first party to activate if one should feel oneself getting sick Lights and siren will get attention of second party retrieving messages or information.
21. Speaker connected to device to record and playback for transmittal of messages from the first party to the second party. Playback through means of random access memory for storing digitized messages.

A search of the prior art did not disclose any patents noted in the claims of the sole and instant inventor. Below you will find reference that are related to voice fire detector smoke alarms:
1. U.S. Pat. No. 012,497. Issued in the name of Routman; Brent E.
2. U.S. Pat. No. 075,242 Issued in the name of Goszyk; Kurt A.
3. U.S. Pat. No. 049,229 Issued in the name of Mitchell; Steven
4. U.S. Pat. No. 319,616 Issued in the name of Nesbit et. al.

The following references are related to voice warning system for fire accidents.
1. U.S. Pat. No. 5,724,020. Issued in the name of Hsu; Ching-Fu.
2. U.S. Pat. No. 3,906,491. Issued in the name of Gosswiller et al.

The following references are related to communicative environmental alarm system with voice indication.
1. U.S. Pat. No. 6,323,780. Issued in the name of Morris; Gary J.
2. U.S. Pat. No. 4,258,332. Issued in the name of Topol, ET. Al.
3. U.S. Pat. No. 4,531,114. Issued in the name of Kim
4. U.S. Pat. No. 5,460,228. Issued in the name of Butler

There is definitely a need for a more responsive unit in assisting people when sick or during a time of an emergency. Time wasted or lack of information need not be an issue, when health and lives are at stake. A PVEMAR is badly needed for personal emergency/non emergency information. Think of all the lost children and pets lives this could save. What other invention do we know of that is able to personally assist so many people in so many different locations all at on time no matter where they are located in the world.

### STATEMENT REGARDING FEDERALLY SPONSORED RESEARCH OR DEV

Not Applicable

### REFERENCE TO SEQUENCE LISTING

Not Applicable

### SEQUENCE LISTING

Not Applicable

### DESCRIPTION OF INVENTIONS

1. Field of Invention

My invention relates to a smoke alarm safety device but not limited to environmental emergency conditions, such as a: smoke alarm, carbon monoxide, health conditions, handicaps, emergency assistance or medical challenges. My device fixed but more importantly is Portable (always there to assist you) and will allow your recorded personalized voice with all of your Life-saving information (just like having your doctor around) to be stored and to be released when triggered.

2. Background of the Invention

Fight fires before they start. I believe when a person fails to initiate a plan then a plan for them has already been initiated to fail. So why not start planning to save you and your family lives today.

As documented smoke alarms do save many lives. Think of all the bodies that are found hidden in closets, under beds, in corners and anywhere people think they can escape smoke inhalation. This is one of the greatest reasons people are trapped in burning building. One they are unaware of the damage smoke inhalation can do. Two most people panic before they can even get out of the building and thirdly most people don't know how to properly escape in a fire or all the signs that are for or against them.

The majority of fires occur at night when people are asleep. Smoke and poisonous gases from fire can quickly numb the senses and put you into a deeper sleep. Most people wake up in a disoriented state of mind. Imagine how having the next best thing or person to coach you along as danger invades your home, school, business, work place, or parent's home.

About 86% of homes has detectors today. Your chances of dying in a home fire are cut nearly in half with a smoke detector. Imagine increasing your survival chances because you know all the warning signals to feel for (heat on the door), look for (dark areas on walls or doors), smell for (smoke), areas to approach (escape routes), not to approach (glass), exits to take (stairs), not to take (elevators), etc. You will even save lives and time by recording all this information and more. Oh and of course don't forget to tell your family members your safety destination is located so you will be assured everyone is safe.

Any type of environmental emergency conditions, such as a: smoke alarm, carbon monoxide, tornadoes, floods, etc., can be used for this device.

Almost all fire departments suggest you check batteries weekly as well as changing batteries twice a year. Along with checking batteries check on your very own personalized-recorded message that will assist anyone no matter where they are in your home. Practice; go over the escape plans, from different areas in your home. The most awesome thing is your child will be able to remove the alarm from the wall and carry it with them to save precious and valuable time. The person will not be defined to any area trying to remember what to do next.

Fire injuries reported nationwide fire injury in the home every 23 minutes in 2001. You don't just want to get to safety but I am most sure you would also love to see your love ones unharmed.

South Carolina had the nation highest death ate in 1988 and 1989. Then it introduced a state wide fire-safety program that emphasized smoke-alarm installation and fire safety education.

The state rank had dropped to #6; it is still being used today. And by using the Personal Voice Emergency Message Alarms Responder you will be place fire safety education at your loved one's fingertips.

Remember you can work alarms on every level of the home, in every room, especially bedrooms. With fire safety education right at your fingertips you should draw-up and practice a home fire escape that includes two easy unobstructed exits out of all rooms. You will also be able to store important emergency phone numbers.

Once you record a personalized emergency message that will be able to relate instruction to anyone to your love ones. They will be able to retrieve life saving information to assist them while in danger or need. With the panic button/light your guest and your children would be able to push the button over and over again for instructions.

Personal Voice Emergency Message Alarms Responder Watch

The Personal Voice Emergency Message Alarms Responder Pendant has all of the stunning features same as the Personal Voice Emergency Message Alarms Responder. The difference is that life-saving medical information is recorded by a familiar personalized voice can be recorded into a device such as a wrist pendant, necklace pendant, emergency alarm device. It will allow a person to retrieve a personalized emergency or non-emergency message that will be able to relate, assist or execute information pertaining to the wearer while in danger or need. With the panic button/light the tenant, anyone would be able to push the button over and over again for instructions. The watch will include the time so that a second time controlled watch no have to be worn.

The American Heart Association and the National Heart, Lung, and Blood Institute have launched a new “Act in Time” campaign to increase people's awareness of heart attacks and calling 911 immediately at the onset of heart attack symptoms. Every second counts. Don't always think you will be around people who will know your symptoms and even if they did would they know what to do?

A familiar personalized voice or even your doctor voice is recorded into your PVEMAR watch to store your life-saving personal medical information. Anyone will be able to retrieve the important information you have inside to assist you and call the proper authorities. What is so awesome is that even if you have lost consciousness someone will be able to activate all of your valuable information. That aspirin in your front pocket could save your life. Store this valuable information in your watch.

Imagine if you are a diabetic and you lose consciousness, someone will respond to your Personal Voice Emergency Message Alarms Responder Watch and be able to assist you while waiting for the proper authorities to arrive. Wouldn't you feel better knowing insulin in your purse could save your life? This is a voice message you or your doctor or anyone can record for you. This pendant is especially good for children, as well as animals that may get lost.

Personal Voice Emergency Message Alarms Responder Mulit-Unit

And with the PVEMARU you will be able to offer your guest an enormous amount of security just knowing that the best instructions to safety is right at their fingertips. How safe do you feel when you are out of town when storm warnings are posted? Do you know emergency numbers to call? Most if not all—911 operators will have busy signals. Businesses can greet their guest as they arrive in their rooms with their own personal security escort. Imagine if a child guest swallowed something poisonous and the front desk was busy. Why waste precious time looking up a number when it can be right at your fingertips assuring your guest of their

Personal Voice Emergency Message Alarms Responder Unit will consist of several different types of emergencies. Imagine how safe your guest will feel knowing that they have a personal advisor or escort in their own room. This unit will work well in hotels, motels, and daycare centers, retirement homes, jails, elderly home care facilities and so forth. With a PVEMARU insurance companies should be proud to offer lower insurance rates. The unit will be able to assist guest or anyone who is not familiar with a new surrounding in escaping safely out of a building during any type emergency: tornadoes, floods, fires, bombings, earthquakes and so forth. It will be able to tell you where you are located in the building, the closest exit, and the safest place to hide, and so forth. Imagine how many children have been found huddled in corners when they could have had the opportunity to find their way out to safety. Also with the PVEMARU the unit can be hand carried when assistance is needed outside of the room. The unit itself would be waterproof, as it would be as effective in floods, on cruises, hurricanes, tornadoes, etc. For example; If a fire should start in the building the PVEMARU will be able to be taken off of the wall and be hand carried all the while assisting the guest or your children to safely. Unit is can be removed from the wall after warning signal turns green.

With the panic button/light the tenant, guest, etc. would be able to push the button over and over again for instructions.

### SUMMARY OF INVENTION

It is therefore an objection to provide a newer and improved emergency medical alarm response alarm.

It has features of some present inventions but provide a newer and improved emergency medical alarm response alarm unit with the capability to have the best time reaction or most efficient medical information, when health and lives are at stake during any type of emergency situations.

Brief description according to one to one embodiment of the present invention is designed to assist or aid a sick, endangered, blind, deaf, mute or anyone in need. During an emergency or non-emergency situation the person retrieving the message will not have to guess at what is wrong with the person in need or what type of assistance is needed.

And another feature is by pressing a simple panic button/light a person can feel themselves getting sick and release a pre-recorded voice or siren to warn someone to help.

And another feature is for a sickly person to be able to get out more on their own knowing that real assistance is right at their fingertips. Think of all the people who panic or get sued because they administered the wrong kind of medicine, assistance or did not use the proper procedure.

And the greatest feature is having your very own physician to record his or her instructions, name, phone number, hospital, etc. For anyone retrieving the message to go by.

safety just by pushing the panic button/light. The most exciting thing is that your guest can go over the procedures ahead of time if more reassurance is needed.

Both the PVEMARU and the PVEMAR is designed to record, document, register, retrieve, respond, transcript, help or aid any type voice rather personal, electronic, coded, signed, verbal sounds, ect. For any such use not limited to medical, non medical, greetings, important information, jokes, guidelines of communications, as a basic message carrier or anything similar.

Any language anywhere in the world can be recorded to give anyone that added security or peace of mind.

### BRIEF DESCRIPTION OF DRAWINGS

The advantages and features of the named invention are presented in the more visual, detailed descriptions and in the claims along with the partner drawings. Drawing are identified with such as:

FIG. 1A is a front view of a Personal Voice Emergency Message Alarms Responder indicating the front of a single unit with speakers, name of alarm, emergency button and size of the outer unit.

FIG. 2A is a rear view of a Personal Voice Emergency Message Alarms Responder indicating battery compartment and size of outer unit.

FIG. 3A is a right side view of a Personal Voice Emergency Message Alarms Responder outer size. Unit made of plastic.

FIG. 4A is a left side view of a Personal Voice Emergency Message Alarms Responder outer size. Unit made of plastic

FIG. 5A is a topside view of a Personal Voice Emergency Message Alarms Responder outer size. Unit made of plastic

FIG. 6A is a bottom side view of a Personal Voice Emergency Message Alarms Responder outer size. Unit made of plastic

And also:

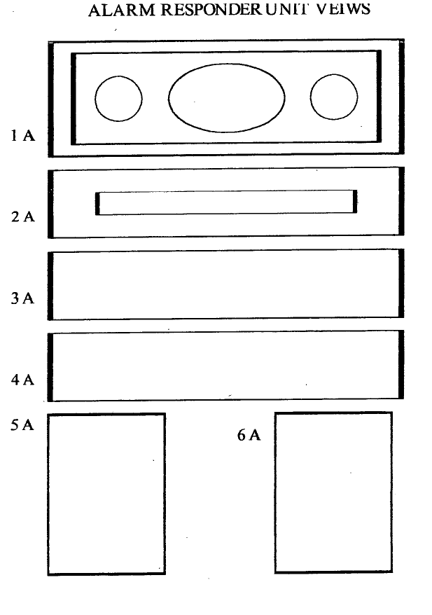

FIG. 1B is a front view of a Personal Voice Emergency Message Alarms Responder Pendant/Watch indicating the front of a single unit with speakers, name of alarm, emergency button and size of the outer unit.

FIG. 2B is a back view of a Personal Voice Emergency Message Alarms Responder Pendant/Watch indicating battery compartment and size of outer unit.

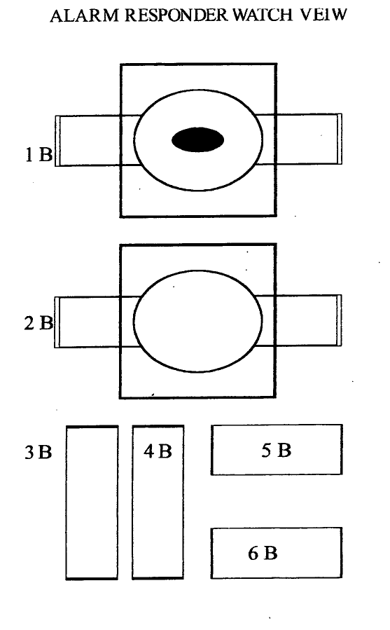

FIG. 3B is a right side view of a Personal Voice Emergency Message Alarms Responder Pendant/Watch outer size. Unit made of plastic

FIG. 4B is a left side view of a Personal Voice Emergency Message Alarms Responder Pendant/Watch outer size. Unit made of plastic

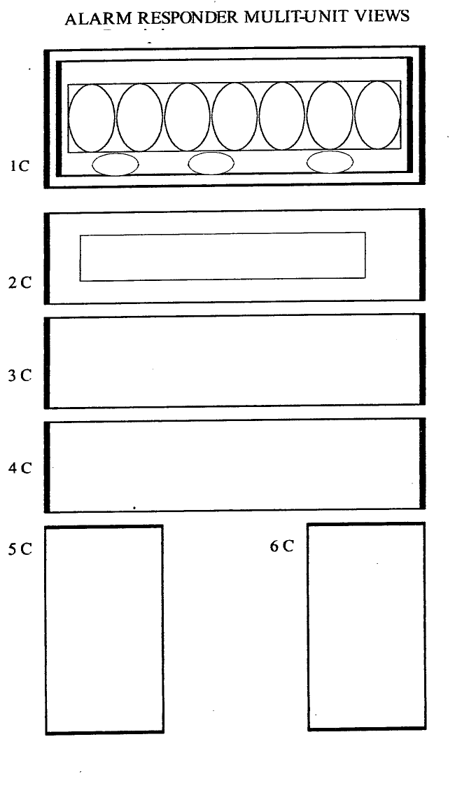

FIG. 5B is a topside view of a Personal Voice Emergency Message Alarms Responder outer size. Unit made of plastic

FIG. 6B is a bottom side view of a Personal Voice Emergency Message Alarms Responder outer size. Unit made of plastic

And Also:

FIG. 1C is a front view of a Personal Voice Emergency Message Alarms Responder Multiple-Unit indicating the front of a single unit with speakers, name of alarm, emergency button and size of the outer unit and multiple emergency indicators buttons.

FIG. 2C is a back view of a Personal Voice Emergency Message Alarms Responder Multiple-Unit indicating battery compartment, electrical plug, and size of outer unit.

FIG. 3C is a right side view of a Personal Voice Emergency Message Alarms Responder Multiple-Unit. Outer size. Unit made of plastic

FIG. 4C is a left side view of a Personal Voice Emergency Message Alarms Responder Multiple-Unit. Outer size. Unit made of plastic

FIG. 5C is a topside view of a Personal Voice Emergency Message Alarms Responder outer size. Unit made of plastic

FIG. 6C is a bottom side view of a Personal Voice Emergency Message Alarms Responder outer size. Unit made of plastic

### SEARCH

Personal Voice Emergency Message, Alarm Responder Multiplex-Unit

A search of the prior arts did not disclose any patents noted in the claims of the sole and instant inventor. Below you will find reference that are related to voice fire detector smoke alarms:
1. U.S. Pat. No. 012,497. Issued in the name of Routman; Brent E.
2. U.S. Pat. No. 075,242 Issued in the name of Goszyk; Kurt A.
3. U.S. Pat. No. 049,229 Issued in the name of Mitchell; Steven
4. U.S. Pat. No. 319,616 Issued in the name of Nesbitet. al.

The following references are related to voice warning system for fire related accidents.
1. U.S. Pat. No. 5,724,020. Issued in the name of Hsu; Ching-Fu.
2. U.S. Pat. No. 3,906,491. Issued in the name of Gosswiller-et al.

The following references are related to communicative environmental alarm system with voice indication.
1. U.S. Pat. No. 6,323,780. Issued in the name of Morris; Gary J.
2. U.S. Pat. No. 4,258,332. Issued in the name of Topol, ET. Al.
3. U.S. Pat. No. 4,531,114. Issued in the name of Kim
4. U.S. Pat. No. 5,460,228. Issued in the name of Butler

### STATEMENT REGARDING FEDERALLY SPONSORED RESEARCH OR DEV.

Not Applicable

### REFERENCE TO SEQUENCE LISTING

Not Applicable

### SEQUENCE LISTING

Not Applicable

### DESCRIPION OF INVENTIONS

The PVEMAR Watch

Personal Voice Emergency Message, Alarm Responder device able to be worn, carried etc. while assisting with medical, non-medical conditions.

My invention relates to a medical alarm safety device but not limited to environmental emergency conditions, non-emergency conditions, such as health conditions, handicaps, emergency assistance, or medical challenges. My devices can be fixed but more importantly is portable (always there to assist you) and will allow your recorded personalized voice with all of your life-saving information (just like having you loved ones or your doctor around) to be stored and to be released when activated and can all be used for emergency or nonemergency conditions.

The PVEMAR watch can be worn as a pendant, device, necklace, hand carries, bracelet, locket, armlet, wristlet, bangle, ornament, jewelry, brooch, or anything similar.

### DESCRIPTION OF INVENTIONS

The PVEMAR Unit

Personal Voice Emergency Message, Alarm Responder Unit, box, container, etc. has the ability to readily assist and save your life in dangerous situation.

The PVEMAR unit is compact and ease to carry. It can be designed in a container or unit of plastic, wood, etc., and or natural and not limited to man made materials. The units can also be made into a non-burning container. The device places every important information at your fingertips 24-7 around the clock when needed.

Imagine increasing your survival chances because you know all the warning signals to look for: feel for heat on the door, look for dark areas on walls or doors, smell for smoke, where escape routes are, not to approach glass, exits to take stairs, not elevators, etc. You will even save lives and time by recording all this information and more. Of course don't forget to tell your family members where your safety destination is located so you will be assured everyone is safe.

### DESCRIPTION OF INVENTIONS

The PVEMAR Multiplex System

Personal Voice Emergency Message, Alarm Responder Multiplex Unit, box, container, etc. has the ability to readily assist you. It can even save your life in dangerous situation in an unfamiliar situation. Fire injuries reported nationwide fire injury in the home every 23 minutes in 2001. You don't just want to get to safety but I am most sure you would also love to see your love ones, customers, etc., unharmed. Remember you can place alarms on every level of the home or hotels, or in every room, especially bedrooms. With fire safety education right at your fingertips you should draw-up and practice a home fire escape that includes two easy unobstructed exits out of all rooms. Guest will be able to practice after settling in. You will also be able to store important emergency phone numbers.

Once you record a personalized emergency message that will be able to relate instruction to anyone to your love ones. They will be able to retrieve life saving information to assist them while in danger or need. With the panic button/light your guest and your children would be able to push the button over and over again for instructions.

For example; If a fire should start in the building the PVEMARU will be able to be taken off of the wall and be hand carried all the while assisting the guest or your children to safety. Unit is can be removed from the wall after warning signal turns green.

### BACKGROUND OF THE INVENTION

Personal Voice Emergency Message Alarms Responder Unit

Fight fires before they start. I believe that when a person fails to plan, they have already planned to fail. So why not start planning to save yourself and your family lives today. As documented, smoke alarms do save many lives. Think of all the people that are found hidden in closets, under beds, in corners and anywhere people think they can escape smoke inhalation. This is one of the greatest reasons people are trapped in burning building. They are unaware of the damage smoke inhalation can do and most people panic before they can even get out of the building. Most people don't know how to properly escape in a fire. The majority of fires occur at night when people are asleep. Smoke and poisonous gases from fire can quickly numb the senses and put you into a deeper sleep. Or you can be one of those people who wake up in a disoriented state of mind. Imagine how having the next best thing or person to coach you along as danger invades your home, school, business, work place, or a love one's home: a PVEMAR watch. About 86% of homes has detectors today. Your chances of dying in a home fire are cut nearly in half with a smoke detector. Environmental emergency conditions, such as a smoke, fires, carbon monoxide, tornadoes, floods, earthquakes, etc., can be used for all of these devices. Almost all fire departments suggest you check batteries weekly as well as changing batteries twice a year. Along with checking batteries check on your very own personalized-recorded message that will assist anyone no matter where they are in your home. Practice going over the escape plans, from different areas in your home. The most awesome thing is your child will be able to remove the alarm from the wall and carry it with them to save precious and valuable time. The person will not be defined to any area trying to remember what to do next. Imagine if we had this during 911 at the Trade Center, people could have been tracked for days, easily.

Personal Voice Emergency Message Alarm Responder Watch

The PVEMAR Watch has all of the stunning features same as the PVEMAR. The difference is that life-saving medical information is recorded by a familiar personalized voice can be recorded into a device such as a wrist pendant, necklace pendant, emergency alarm device. It will allow a person to retrieve a personalized emergency or non-emergency message that will be able to relate, assist or execute information pertaining to the wearer while in danger or need. With the panic button/light the tenant, anyone would be able to push the button over and over again for instructions. The PVEMAR watch will include the time so that only one watch need to be worn.

The American Heart Association and the National Heart, Lung, and Blood Institute have launched a new “Act in Time” campaign to increase people's awareness of heart attacks and calling 911 immediately at the onset of heart attack symptoms. Every second counts. Don't always think you will be around people who will know your symptoms and even if they did would they know what to do? A familiar personalized voice or even your doctor voice is recorded into your PVEMAR watch to store your life-saving personal medical information. Anyone will be able to retrieve the important information you have inside to assist you and call the proper authorities. What is so awesome is that even if you have lost consciousness someone will be able to activate all of your valuable information. That aspirin in your front pocket could save your life. Store this valuable information in your watch. Imagine that if you are a diabetic and you lose consciousness, someone will respond to your PVEMAR Watch and be able to assist you while waiting for the proper authorities to arrive. Wouldn't you feel better knowing insulin in your purse could save your life? This is a voice message you or your doctor or anyone can record

Personal Voice Emergency Message Alarms Responder Multiplex-Unit

With the PVEMAR Multiplex-Unit you will be able to offer your guest an enormous amount of security just knowing that the best instructions to safety is right at their fingertips. How safe do you feel when you are out of town when storm warnings are posted? Do you know emergency numbers to call? Most if not all 911 operators will have busy signals. Businesses can greet their guest as they arrive in their rooms with their own personal security escort the PVEMAR Unit. Imagine if a child guest swallowed something poisonous and the front desk was busy. Why waste precious time looking up a number when it can be right at your fingertips. Assuring your guest with their Personal Voice Emergency Message Alarms Responder Unit that will consist of several different types of emergency numbers. Imagine how safe your guest will feel knowing that they have a personal advisor or escort in their own room. This unit will work well in hotels, motels, and daycare centers, retirement homes, jails, elderly home care facilities and so forth. With a PVEMARU insurance companies should be proud to offer lower insurance rates. The unit will be able to assist guest or anyone who is not familiar with a new surrounding in escaping safely out of a building during any type emergency: tornadoes, floods, fires, bombings, earthquakes and so forth. It will be able to tell you where you are located in the building, the closest exit, and the safest place to hide, and so forth. Imagine how many children have been found huddled in corner when they could have had the opportunity to find their way out to safety. Also with the PVEMARU it can be hand carried when assistance is needed outside of the room. The unit itself would be waterproof, as it would be as effective in floods, on cruises, hurricanes, tornadoes, etc.

### FIELD OF INVENTION

The PVEMAR Watch

It is therefore an objection to provide a newer and improved emergency medical response alarm.

It has features of some present inventions but provide a newer and improved emergency medical alarm response alarm unit with the capability to have the best time reaction or most efficient medical information, when health and lives are at stake during any type of emergency situations.

Brief description according to one to one embodiment of the present invention is designed to assist or aid a sick, endangered, blind, deaf, mute or anyone in need. During an emergency or non-emergency situation the person retrieving the message will not have to guess at what is wrong with the person in need or what type of assistance is needed.

And another feature is by pressing a simple panic button/light a person can feel themselves getting sick and release a pre-recorded voice or siren to warn someone to help.

And another feature is for a medically challenged person to be able to get out more on their own knowing that real assistance is right at their fingertips.

Think of all the people who panic or get sued because they administered the wrong kind of medicine, assistance or did not use the proper procedure.

And the greatest feature is having your very own physician to record his or her instructions, name, phone number, hospital, etc. For anyone retrieving the message to respond to safely just by pushing the panic button/light.

### FIELD

The PVEMAR Multiplex System

With the panic button/light the tenant, guest, etc. would be able to push the button over and over again for instructions.

South Carolina had the nation highest death ate in 1988 and 1989. Then it introduced a state wide fire-safety program that emphasized smoke-alarm installation and fire safety education. The state rank had dropped to #6; it is still being used today. And by using the Personal Voice Emergency Message Alarms Responder Multiplex Unit you will be place fire safety education at your guest's fingertips. The most exciting thing is that your guest can go over the procedures ahead of time if more reassurance is needed._This will provide them with the ability to know their exact location rather than depending on a drawing on the wall that they cannot see through smoke anyway.

The PVEMAR Unit

Both the PVEMARU and the PVEMAR is designed to record, document, register, retrieve, respond, transcript, help or aid any type voice rather personal, electronic, coded, signed, verbal sounds, ect. For any such use not limited to medical, non medical, greetings, important information, jokes, guidelines of communications, as a basic message carrier or anything similar. Any language anywhere in the world can be recorded to give anyone that added security or peace of mind.

### BRIEF DESCRIPTION OF DRAWINGS

Personal Voice Emergency Message Alarms Responder Unit

The advantages and features of the named invention are presented in the more visual detailed descriptions and in the claims along with the partner drawings.

Drawing are identified with such as:

FIG. 1A is a front view of a Personal Voice Emergency Message Alarms Responder indicating the front of a single unit with speakers, name of alarm, emergency button and size of the outer unit.

FIG. 2A is a rear view of a Personal Voice Emergency Message Alarms Responder indicating battery compartment and size of outer unit

FIG. 3A is a right side view of a Personal Voice Emergency Message Alarms Responder outer size. Unit made of plastic.

FIG. 4A is a left side view of a Personal Voice Emergency Message Alarms Responder outer size. Unit made of plastic

FIG. 5A is a topside view of a Personal Voice Emergency Message Alarms Responder outer size. Unit made of plastic

FIG. 6A is a bottom side view of a Personal Voice Emergency Message Alarms Responder outer size. Unit made of plastic

PVEMAR Watch/Pendant

And also:

FIG. 1B is a front view of a Personal Voice Emergency Message Alarms Responder Pendant/Watch indicating the front of a single unit with speakers, name of alarm, emergency button and size of the outer unit.

FIG. 2B is a back view of a Personal Voice Emergency Message Alarms Responder Pendant/Watch indicating battery compartment and size of outer unit.

FIG. 3B is a right side view of a Personal Voice Emergency Message Alarms Responder Pendant/Watch outer size. Unit made of plastic

FIG. 4B is a left side view of a Personal Voice Emergency Message Alarms Responder Pendant/Watch outer size. Unit made of plastic

FIG. 5B is a topside view of a Personal Voice Emergency Message Alarms Responder outer size. Unit made of plastic

FIG. 6B is a bottom side view of a Personal Voice Emergency Message Alarms Responder outer size. Unit made of plastic

PVEMAR Multi-Unit

And Also:

FIG. 1C is a front view of a Personal Voice Emergency Message Alarms Responder Multiple-Unit indicating the front of a single unit with speakers, name of alarm, emergency button and size of the outer unit and multiple emergency indicators buttons.

FIG. 2C is a back view of a Personal Voice Emergency Message Alarms Responder Multiple-Unit indicating battery compartment, electrical plug, and size of outer unit.

FIG. 3C is a right side view of a Personal Voice Emergency Message Alarms Responder Multiple-Unit. Outer size. Unit made of plastic

FIG. 4C is a left side view of a Personal Voice Emergency Message Alarms Responder Multiple-Unit Outer size. Unit made of plastic

FIG. 5C is a topside view of a Personal Voice Emergency Message Alarms Responder outer size. Unit made of plastic

FIG. 6C is a bottom side view of a Personal Voice Emergency Message Alarms Responder outer size. Unit made

1. The PVEMAR watch/pendant is far better than any dog tag that the U.S. Armed Forces uses. Vital and important information is stored inside to assist wounded, active, dead or captured soldiers. One would be able to store only what they needed to input for their purpose. Words or codes can be stored into the device. The PVEMAR Digital Device saves messages and can be erased and re-recorded. A flashing message counter with a panic siren button for the first party to activate if one should feel oneself getting sick. Lights and siren will get attention of second party retrieving messages or information. The PVEMAR watch is also able to assist in all medical conditions limited and not limited to one or more of man-made, environments, heart conditions, pregnancy, etc. Not limited to use by or for children, adults, babies, animals, pets, handicaps, nursing homes patients, elderly, kidnappings, nor people or persons of all kind, all ages, culture or nationality, etc. Not limited to retrieval or translating of messages for or of foreign, different and all languages in need of verbal, coded or signal personalized instructions. These devices can even be inserted in or on wheel chairs, in vehicles, walkers, or any other medical assistance devices and or not limited to related objects for inside or outside of the home. All areas of storage is convenient for recording and retrieving of said parties. A medical alarm system for emergency information for recording of a first party message of life saving techniques with a combination of one or more siren or loud tone and personal recorded familiar voice messages for the second party's playback and retrieval. Recorded messages not limited to important, non-important information. The device can also be used as a homing device to locate someone. The device can also be hand carried or worn on or outside of your person.

2. My claim of; The PVEMAR Multi-Unit can be used for one or more messages. The units can be used for any environmental emergency conditions, such as: smoke, carbon monoxide, fire, tornadoes, earthquakes, etc. The unit can or will house a signal to the fire emergency assistance calling circuit through a telephone to a fire department, police station or other emergency personnel, alerting them of the situation. Allowing a recorded personalized voice to be released when triggered by detection of one or more of heat censored, voice commands, smoke detection, panic button release, pushing of on/off buttons, pull, remote control, thus it will allow a person listening to respond correctly and quickly. The life saving devices will be able to personally assist anyone because of its ability to be hand-carried. It can be used in relations to life threatening and non-life threatening situations. Power failure protection is used to save messages during an electrical power outage or low battery interruption. The unit will be battery powered with rechargeable back-up battery compartments, and electrical powered with an emergency light. A person will be able to go anywhere with the PVEMAR, multiplex system as it can even be waterproof and worn on boat, beaches, water parks, scuba diving, swimming, pools, etc. There is definitely a need for a more responsive unit in assisting people when sick or during a time of an emergency. Time wasted or lack of information need not be an issue, when health and lives are at stake. These life saving devices relates to a smoke alarm safety device. The most important of all is the ability to be in a new state in a unfamiliar hotel room and be able to receive personal assistance right where you are located in the building. Each individual unit will be able to assist many people at the same time. With the unit you are able to input many different emergency situation at one time giving anyone the opportunity of choices pertining to their situations. You can input important, non-important tourist information.

3. My claim of; The PVEMAR Single Unit is badly needed for personal emergency/non-emergency information. A person will be able to go anywhere with the PVEMAR, single unit. It can also be water and fire proofed. Think of all the children and elderly love one's lives this could save. What other invention do we know of that is able to personally assist so many people in so many different locations all at one time no matter where they are located in the world. It will not matter what language a person speaks nor the type of medical condition the person has. Emergency instructions are not limited to fire, tornado, flood, heart attacks, or any kind of medical conditions. One touch personal voice messages playback and resets itself to be used time and time again. Why take a chance on your children, family, elderly love one's, or even friends safety. Why even take a chance on their lives? Most people don't always know what to do in certain emergencies, especially children. What would be the next best thing to assist your love ones? Why not have messages of a pre-recorded personalized and familiar voice? Voices are recorded on digital tape-less or tapes allowing message to be taped as long as the caller speaks, up to 45 minutes or more. Hearing mom or dad's voice can be right at their fingertips and easily ease a child's first day of school, a hospital stay, escaping a home fire, daycare experiences, etc. It goes anywhere you go and is able to say anything you want it to say.
